(19) United States
(12) Patent Application Publication
(10) Pub. No.: US 2016/0190881 A1
(43) Pub. Date: Jun. 30, 2016

(54) MOTOR

(71) Applicant: Nidec Corporation, Kyoto (JP)

(72) Inventors: Tadayuki KANATANI, Kyoto (JP); Kazuya KITAJI, Kyoto (JP); Kumiko ARIMA, Kyoto (JP); Shota IKENO, Kyoto (JP)

(21) Appl. No.: 14/822,940

(22) Filed: Aug. 11, 2015

(30) Foreign Application Priority Data
Dec. 25, 2014 (JP) 2014-261843

(51) Int. Cl. H02K 1/28; H02K 1/27; H02K 1/02

(52) U.S. Cl. CPC H02K 1/28; H02K 1/02; H02K 1/2706

(57) ABSTRACT

A motor includes a stationary unit and a rotary unit arranged to rotate with respect to the stationary unit about a center axis extending in an up-down direction. The rotary unit includes a substantially cylindrical rotor holder, a plurality of magnets disposed radially inward of the rotor holder and arranged along a circumferential direction, and a non-magnetic magnet holder fixed to an inner circumferential surface of the rotor holder and arranged to hold the magnets. The magnet holder includes a plurality of pillars extending in the up-down direction and arranged to position the magnets in the circumferential direction, and a first ring and a second ring arranged to interconnect the pillars at positions spaced apart in the up-down direction. The first ring is positioned radially outward of the second ring, and the second ring is positioned radially inward of outer circumferential surfaces of the pillars.

### BACKGROUND OF THE INVENTION

1. Field of the Invention

The present invention relates to a motor and, more particularly, to a motor provided with a non-magnetic magnet holder for holding a plurality of magnets.

2. Description of the Related Art

In an outer-rotor-type brushless motor, a rotor magnet is arranged on the inner circumferential surface of a rotor holder. A cylindrical magnet is used as the rotor magnet. Instead of the cylindrical magnet, a plurality of magnets arranged in a circumferential direction may be used as the rotor magnet. However, it is not easy to evenly dispose a plurality of magnets having a strong magnetic force along the inner circumferential surface of the rotor holder and to fix the magnets to the inner circumferential surface of the rotor holder. Thus, there is conventionally known a motor provided with a magnet holder for holding a plurality of magnets arranged in a circumferential direction (see, e.g., Japanese Patent Application Publication No. 2009-303362).

In the motor disclosed in Japanese Patent Application Publication No. 2009-303362, a plurality of magnets 2a to 2d is arranged along a circumferential direction within a cylindrical yoke 1 using a magnet holder 10 made of a non-magnetic elastic body. The magnet holder 10 is configured by a plurality of columnar portions 10a to 10d and two ring-shaped portions 10e and 10f. The magnets 2a to 2d are disposed in the spaces existing between the columnar portions 10a to 10d adjoining each other. Furthermore, the motor includes auxiliary yokes 5a to 5d formed independently of the yoke 1. The auxiliary yokes 5a to 5d are disposed in the recesses 13 defined by the cutout portions 12 formed in the outer peripheral ends of the magnets 2a to 2d adjoining each other and the outer peripheries of the columnar portions 10a to 10d.

In the motor of the related art, the magnets need to be radially attached to the magnet holder for holding the magnets. This poses a problem in that the assembly work is complicated. Moreover, the magnet holder is not shaped such that a mold can be removed in two different directions. This is problematic in that the magnet holder cannot be formed using a two-direction removal mold.

Under the aforementioned circumstances, the present invention provides a motor capable of facilitating an assembly work. Furthermore, the present invention provides a motor which makes it possible to cost-effectively manufacture a magnet holder for a motor through the use of a two-direction removal mold.

### SUMMARY OF THE INVENTION

In one illustrative embodiment of the subject application, there is provided a motor, including: a stationary unit; and a rotary unit arranged to rotate with respect to the stationary unit about a center axis extending in an up-down direction, wherein the rotary unit includes a substantially cylindrical rotor holder, a plurality of magnets disposed radially inward of the rotor holder and arranged along a circumferential direction, and a non-magnetic magnet holder fixed to an inner circumferential surface of the rotor holder and arranged to hold the magnets, the magnet holder includes a plurality of pillars extending in the up-down direction and arranged to perform positioning of the magnets in the circumferential direction, and a first ring and a second ring arranged to interconnect the pillars at positions spaced apart in the up-down direction, the first ring is positioned radially outward of the second ring, and the second ring is positioned radially inward of outer circumferential surfaces of the pillars.

By employing the aforementioned configuration, the first ring and the second ring can interconnect the pillars at the positions spaced apart in the up-down direction. It is therefore possible to secure the strength of the magnet holder and to accurately perform the positioning of the magnets in the circumferential direction.

According to the present invention, it is possible to facilitate the assembly work of the motor. Furthermore, it is possible to cost-effectively manufacture the magnet holder for the motor through the use of a two-direction removal mold.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional view showing one configuration example of a motor M1 according to one illustrative embodiment of the present invention.

FIG. 2 is a perspective view of a magnet holder 22 which is seen obliquely from above.

FIG. 3 is a perspective view of the magnet holder 22 which is seen obliquely from below.

FIG. 4 is a plan view of the magnet holder 22 which is seen in the direction of an arrow A in FIG. 2.

FIG. 5 is a plan view of the magnet holder 22 which is seen in the direction of an arrow B in FIG. 2.

FIG. 6 is a sectional view of the magnet holder 22 taken along a cutting line C-C in FIG. 4.

FIG. 7 is a perspective view of the magnet holder 22 which is seen obliquely from above after rotor magnets 23 are mounted to the magnet holder 22.

FIG. 8 is a plan view of the magnet holder 22 which is seen in the direction of an arrow D in FIG. 7 after the rotor magnets 23 are mounted to the magnet holder 22.

FIG. 9 is a plan view of the magnet holder 22 which is seen in the direction of an arrow E in FIG. 7 after the rotor magnets 23 are mounted to the magnet holder 22.

FIG. 10 is a sectional view of a rotor holder 21 taken along a cutting line C-C in FIG. 4 after the magnet holder 22 is mounted to the rotor holder 21.

FIG. 11 is a partially enlarged view of a cross section of the rotor holder 21 taken along a cutting line orthogonal to an axial direction after the magnet holder 22 is mounted to the rotor holder 21.

FIGS. 12A, 12B and 12C are views showing different configuration examples of the rotor magnets 23 according to another illustrative embodiment of the present invention.

FIG. 13 is a view showing one configuration example of major parts of a motor M1 according to a further illustrative embodiment of the present invention.

FIG. 14 is a view showing one configuration example of major parts of a motor M1 according to a still further illustrative embodiment of the present invention.

FIGS. 15A to 15D are views showing different configuration examples of major parts of a motor M1 according to a yet still further illustrative embodiment of the present invention.

### DETAILED DESCRIPTION OF THE PREFERRED EMBODIMENTS

Hereinafter, illustrative embodiments of the present invention will now be described with reference to the accompanying drawings. In the subject specification, for the sake of convenience, the direction of a center axis J of a motor will be regarded as an up-down direction. However, this is not intended to limit the in-use posture of the motor according to the present invention. Furthermore, the direction of the center axis J of the motor will be simply referred to as “axial direction”. The radial direction and the circumferential direction about the center axis J will be simply referred to as “radial direction” and “circumferential direction”, respectively.

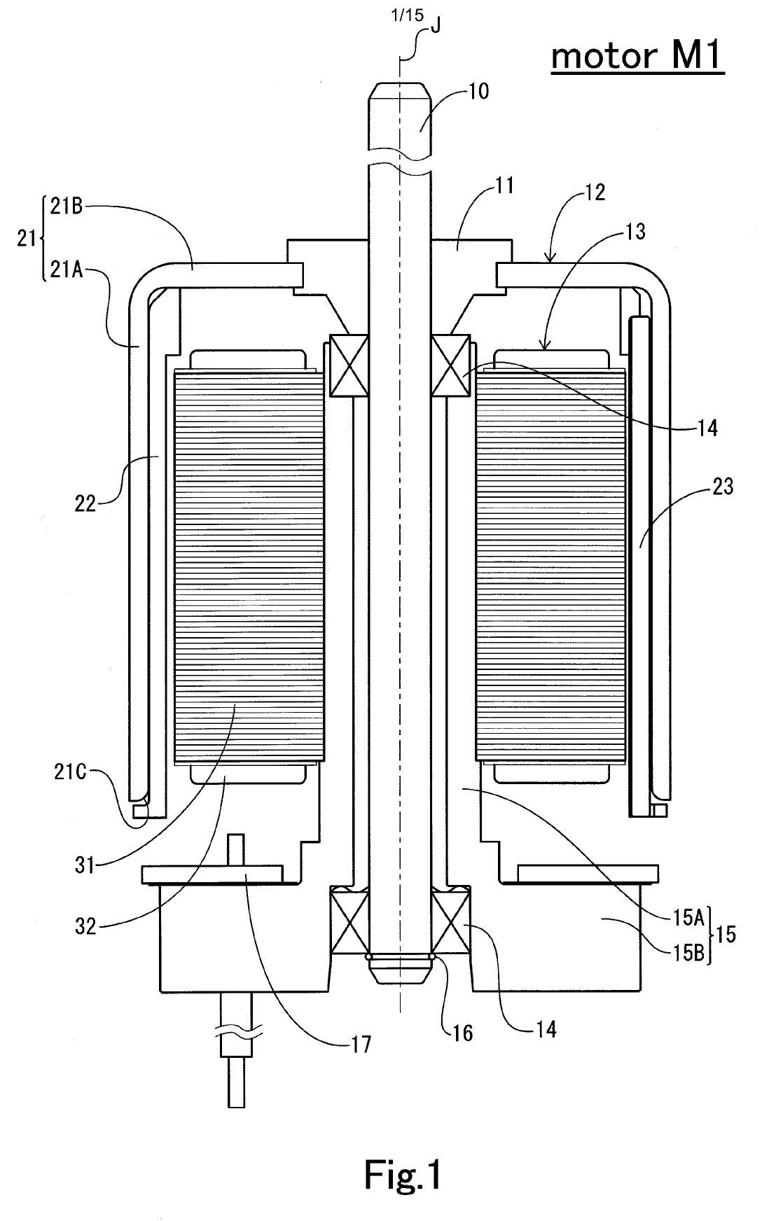

FIG. 1 is a sectional view showing one configuration example of a motor M1 according to one preferred embodiment of the present invention. The motor M1 may be used as a drive power source of a drive unit for a home appliance, office equipment, medical equipment, a motor vehicle or the like. The motor M1 preferably includes a stationary unit fixed to a frame of a drive unit and a rotary unit rotatably supported by the stationary unit. The rotary unit preferably includes a shaft 10, a hub 11 and a rotor 12. On the other hand, the stationary unit preferably includes a stator 13, two bearings 14, a bracket 15, a circuit board 17 and a wiring cable. The respective parts will now be described in detail.

The shaft 10 is a cylindrical columnar member extending in an axial direction (or an up-down direction) and is supported by two bearings 14 spaced apart in the axial direction. The shaft 10 rotates about a center axis J.

The hub 11 is a member which fixes the rotor 12 to the shaft 10. The hub 11 has an annular shape. The shaft 10 is press-fitted to the inner circumferential surface of the hub 11. The hub 11 is fixed to the shaft 10 at the more axially upward side than the upper bearing 14. Furthermore, a rotor holder 21 is fixed to the outer circumferential surface of the hub 11.

The rotor 12 is a member which rotates together with the shaft 10. The rotor 12 relatively rotates with respect to the stator 13. The rotor 12 preferably includes a rotor holder 21, a magnet holder 22 and rotor magnets 23. The rotor holder 21 is made of a magnetic material having a closed-top cylinder shape. The rotor holder 21 preferably includes a cylinder portion 21A and a cover portion 21B. The rotor holder 21 includes an opening portion 21C formed at the axial lower side thereof.

The cylinder portion 21A has, e.g., a substantially cylindrical shape, and is disposed radially outward of the stator 13. The cover portion 21B is a plate-shaped portion which extends radially inward from the upper end of the cylinder portion 21A. The cover portion 21B is disposed above the stator and is supported by the hub 11. The magnet holder 22 is formed into, e.g., a cylindrical shape, and is made of, e.g., a non-magnetic material such as a resin or the like. The magnet holder 22 is fixed to the inner circumferential surface of the rotor holder 21. The magnet holder 22 holds a plurality of rotor magnets 23 such that the rotor magnets 23 are arranged along the circumferential direction. The rotor magnets 23 are permanent magnets having an axially-extending shape. The rotor magnets 23 are disposed on the inner circumferential surface of the cylinder portion 21A of the rotor holder 21.

The stator 13 is an armature of the motor M1. The stator 13 has, e.g., an annular shape. The stator 13 is fixed to the bracket 15. Furthermore, the stator 13 is disposed radially inward of the rotor 12. The outer circumferential surface of the stator 13 is radially opposed to the rotor magnets 23 across a gap. The stator 13 preferably includes cores 31 and coils 32. Each of the cores 32 is a laminated body formed by laminating a plurality of electromagnetic steel plates in the axial direction (or the up-down direction). The coils 32 are configured by lead wires wound around the cores 31. As a drive current is allowed to flow through the lead wires, magnetic fluxes are generated within the cores 31 as magnetic cores. Thus, circumferential torque is generated between the cores 31 and the rotor magnets 23, whereby the shaft 10 rotates about the center axis J.

The bearings 14 are members which rotatably support the shaft 10. For example, ball bearings are used as the bearings 14. Each of the bearings 14 preferably includes an inner race and an outer race which hold rolling elements therebetween. The outer races of the bearings 14 are respectively fitted in large-diameter portions of a cylinder portion 15A of the bracket 15 with a small-diameter portion of the cylinder portion 15A therebetween. On the other hand, the inner races of the bearings 14 are disposed between the hub 11 and a fixing ring 16, both of which are fixed to the shaft 10. The fixing ring 16 is fixed to the shaft 10 at the more axially downward side than the lower bearing 14.

The bracket 15 is a member which supports the stator 13, the bearings 14 and the circuit board 17. The bracket 15 preferably includes the cylinder portion 15A press-fitted to an inner circumferential surface of the stator 13 and a flange portion 15B extending radially outward from a lower end of the cylinder portion 15A. The bearings 14 are accommodated inside the cylinder portion 15A. Furthermore, the circuit board 17 is disposed on an upper surface of the flange portion 15B.

The circuit board 17 is a board mounted with an electronic circuit for supplying a drive current to the coils 32. The circuit board 17 is formed of a circular plate-shaped body. The circuit board 17 is disposed axially below the rotor 12 and is opposed to the opening portion 21C of the rotor holder 21. Furthermore, the circuit board 17 has a through-hole corresponding to the bracket 15.

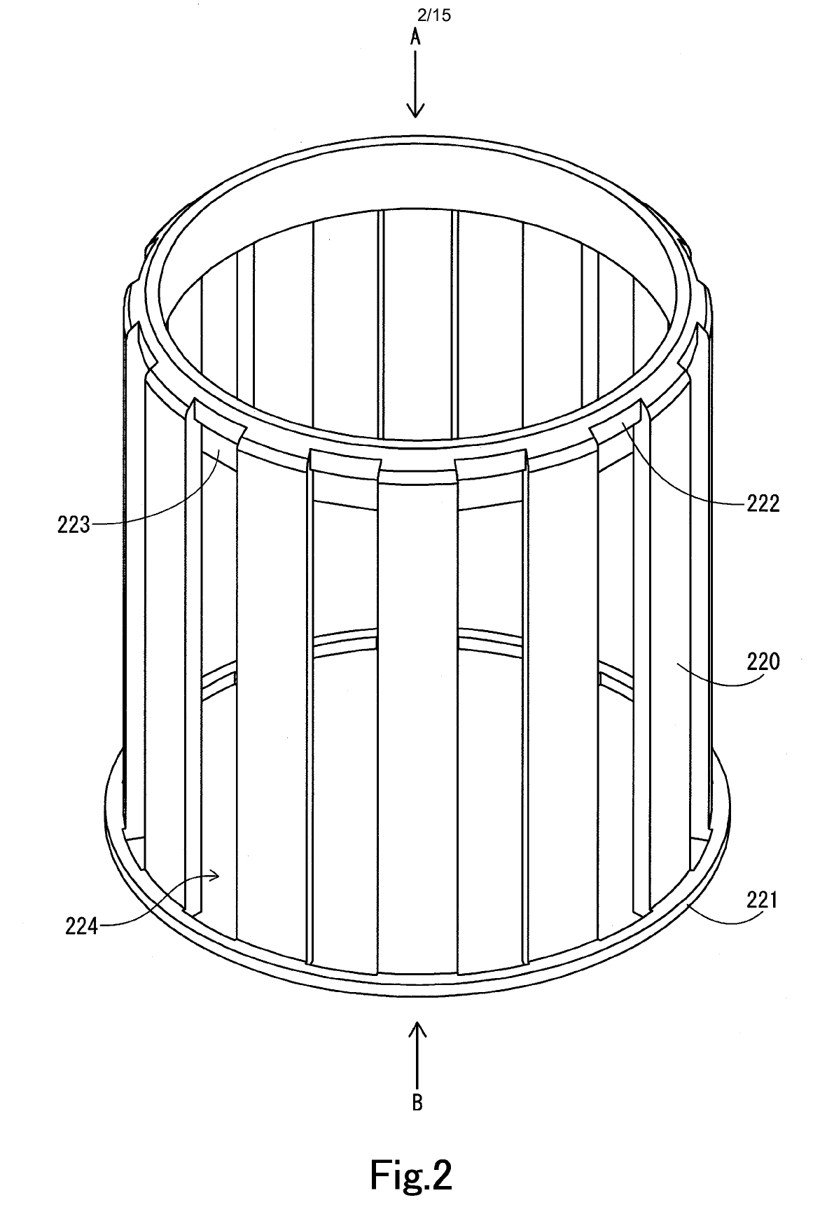

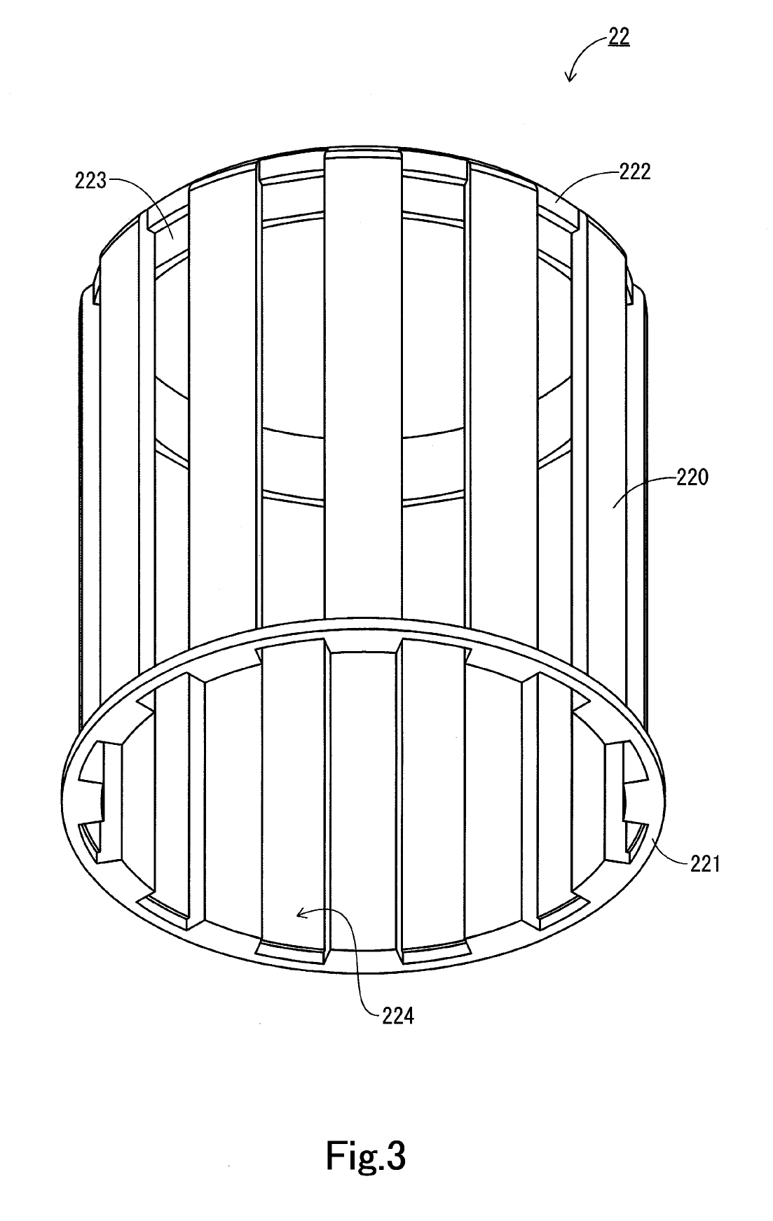

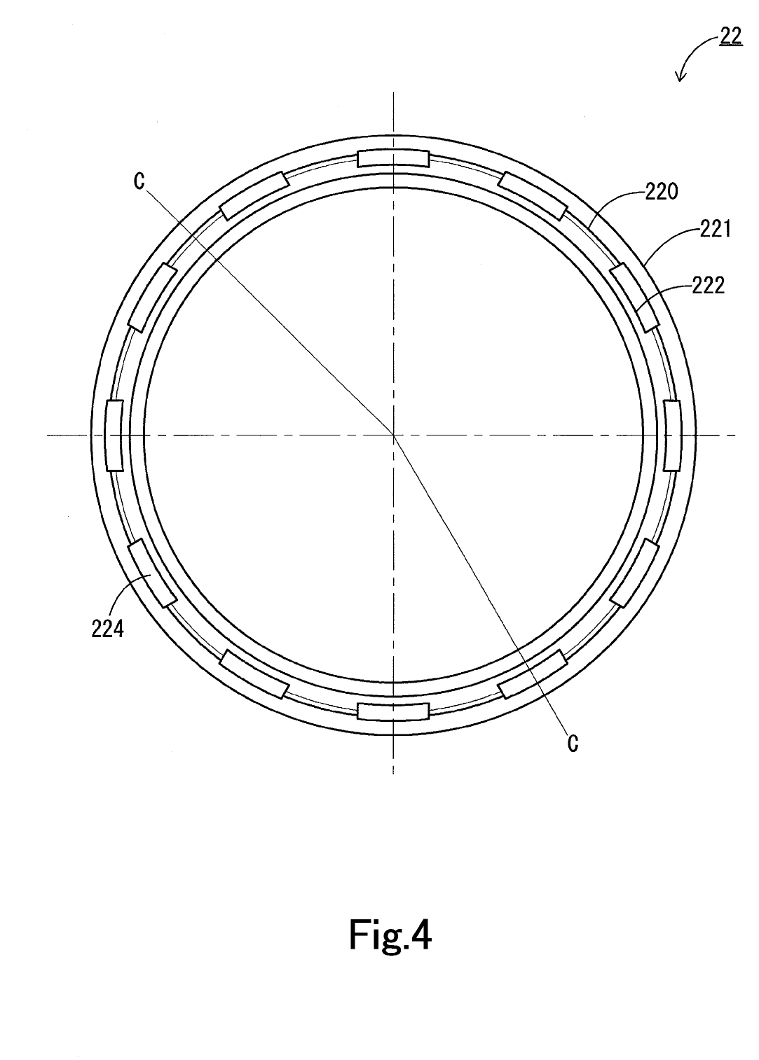

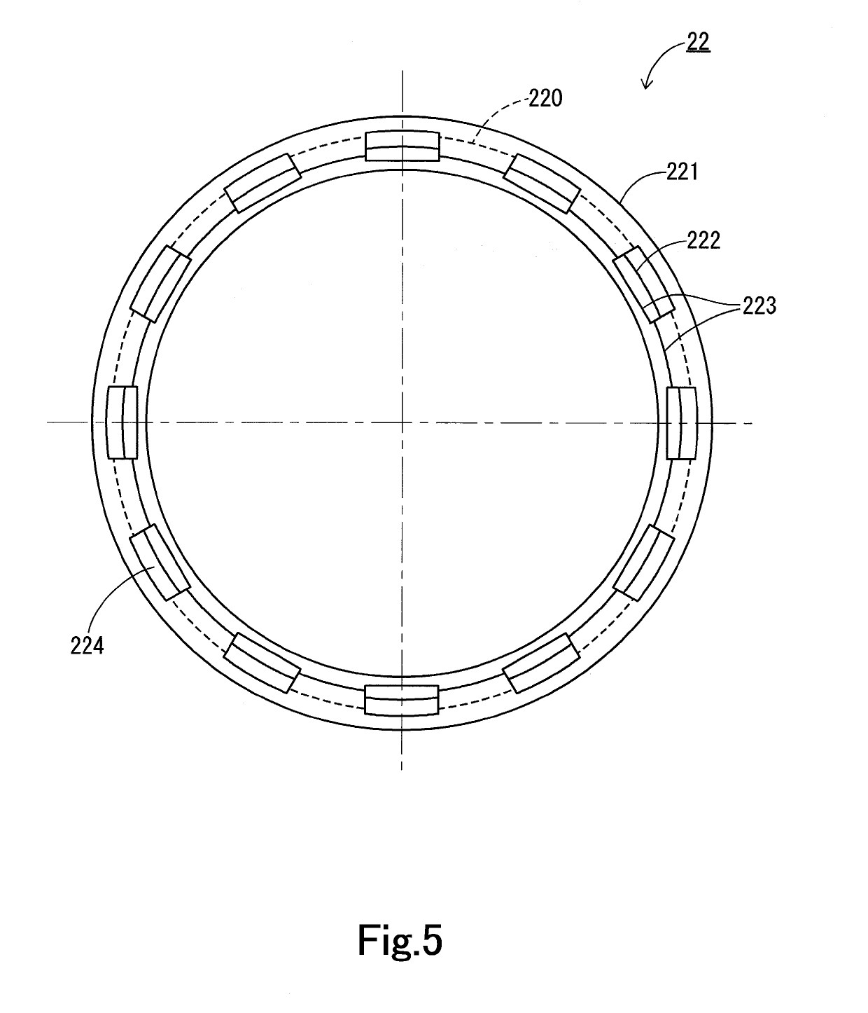

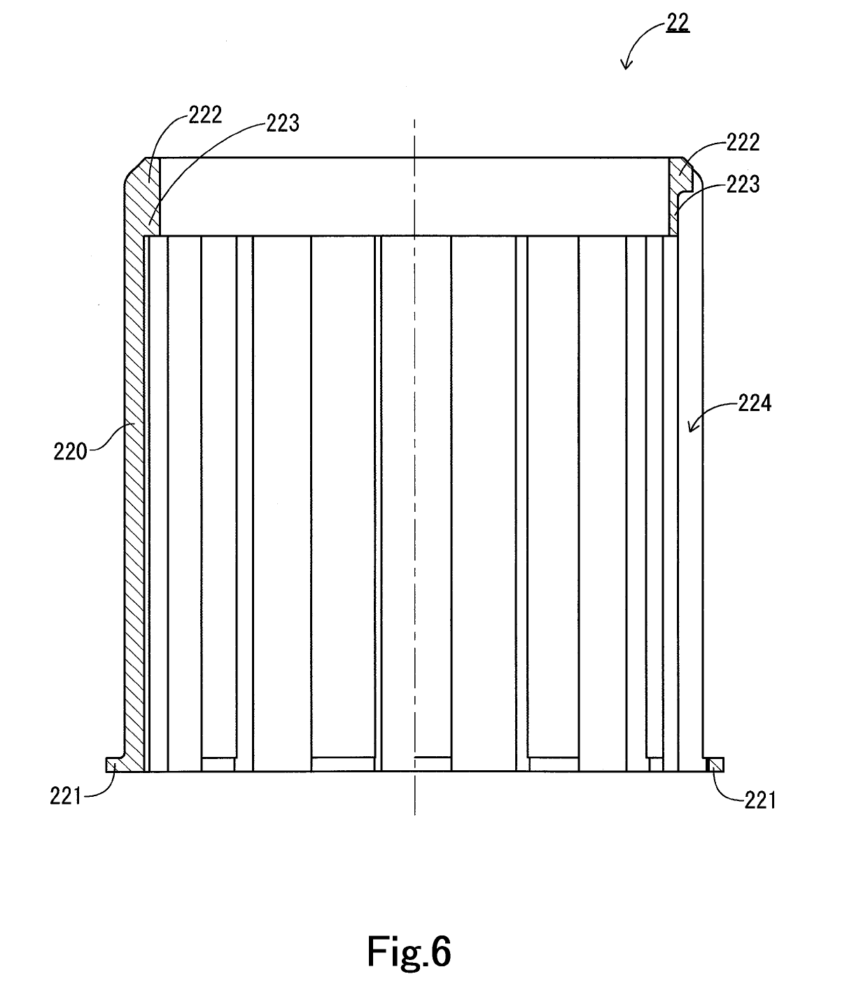

FIGS. 2 to 6 are views showing one configuration example of the magnet holder 22 to which the rotor magnets 23 are not mounted. FIG. 2 is a perspective view of the magnet holder 22 which is seen obliquely from above. FIG. 3 is a perspective view of the magnet holder 22 which is seen obliquely from below. FIG. 4 is a plan view (or an arrow A view) of the magnet holder 22 which is seen in the direction of an arrow A in FIG. 2. FIG. 5 is a plan view (or an arrow B view) of the magnet holder 22 which is seen in the direction of an arrow B in FIG. 2. FIG. 6 is a sectional view (or a C-C sectional view) of the magnet holder 22 taken along a cutting line C-C in FIG. 4.

The magnet holder 22 preferably includes a plurality of pillars 220 extending in the axial direction, a first ring 221 interconnecting the lower ends of the pillars 220, a second ring 222 interconnecting the upper ends of the pillars 220, and a wall portion 223 extending axially downward from a lower end of the second ring 222.

The pillars 220 are columnar bodies extending in the axial direction and are arranged along the circumferential direction in a spaced-apart relationship. Each of the pillars 220 is a portion of a cylindrical body centered at the center axis J. The pillars 220 are identical in shape with one another and are disposed at a regular interval. That is to say, each of the pillars 220 is curved in an arc shape and is formed into a substantially flat shape such that an inner circumferential surface and an outer circumferential surface thereof become major surfaces and the radial direction thereof becomes a thickness direction. The structural body configured by the pillars 220 has a cylindrical shape and has a plurality of slits extending in the axial direction. The inner circumferential surface and the outer circumferential surface of each of the pillars 220 are some portions of cylindrical surfaces centered at the center axis J. Furthermore, the circumferential end surfaces of each of the pillars 220 are planar surfaces parallel to the radial direction. The circumferential end surfaces of the adjoining pillars 220 are opposed to each other across a space. The inner circumferential surface or the outer circumferential surface of each of the pillars 220 may be a planar surface orthogonal to the radial direction.

The first ring 221 has a shape of a circular ring centered at the center axis J and interconnects the pillars 220. The first ring 221 is disposed at the axial lower ends of the pillars 220. Moreover, the first ring 221 is disposed radially outward of the pillars 220. That is to say, the inner circumferential surface of the first ring 221 is coincident with the outer circumferential surfaces of the pillars 220 or is positioned radially outward of the outer circumferential surfaces of the pillars 220. In the drawings, the outer diameter of the first ring 221 is constant but the inner diameter of the first ring 221 is larger in the regions corresponding to magnet accommodation portions 224 than in the regions corresponding to the pillars 220. Thus, the outer circumferential surface of the first ring 221 is a cylindrical surface while the inner circumferential surface of the first ring 221 is a cylindrical surface having irregularities.

The second ring 222 has a shape of a circular ring centered at the center axis J and interconnects the pillars 220. The second ring 222 is disposed at the axial upper ends of the pillars 220. Furthermore, the second ring 222 is disposed radially inward of the outer circumferential surfaces of the pillars 220. More specifically, the outer circumferential surface of the second ring 222 is positioned radially inward of the outer circumferential surfaces of the pillars 220. Thus, the outer circumferential surface of the magnet holder 22 corresponding to the upper ends of the pillars 220 is defined by the outer circumferential surfaces of the pillars 220 and the outer circumferential surface of the second ring 222 which are alternately disposed along the circumferential direction. As a result, the outer circumferential surface of the magnet holder 22 corresponding to the upper ends of the pillars 220 becomes a cylindrical surface having irregularities. Furthermore, the inner circumferential surface of the second ring 222 is positioned radially inward of the inner circumferential surfaces of the pillars 220. Thus, the inner circumferential surface of the magnet holder 22 corresponding to the second ring 222 becomes a cylindrical surface. Moreover, the upper end of the second ring 222 is disposed axially above the upper ends of the pillars 220. The upper edge of the outer circumferential surface of the second ring 222 has a round shape or a taper shape with the diameter thereof growing smaller toward the upper end.

The first ring 221 and the second ring 222 interconnect the pillars 220 at the axially spaced-apart positions. By employing this configuration, it is possible to increase the strength of the magnet holder 22. Furthermore, the first ring 221 is positioned radially outward of the outer circumferential surfaces of the pillars 220 while the second ring 222 is positioned radially inward of the outer circumferential surfaces of the pillars 220. By employing this configuration, spaces to become blind spots when seen from the axial upper side and the axial lower side do not exist in the vicinity of the magnet holder 22. Thus, a mold can be removed upward and downward after a molding process. That is to say, when the magnet holder 22 is one-piece molded by a molding method such as an injection molding method or the like, it is possible to cost-effectively manufacture the magnet holder 22 through the use of a two-direction removal mold. Accordingly, it is possible to increase the strength of the magnet holder 22 and to cost-effectively manufacture the magnet holder 22.

The wall portion 223 is a cylindrical portion extending axially downward from the lower surface of the second ring 222. The wall portion 223 is disposed radially inward of the rotor magnets 23. Furthermore, the axial length of the wall portion 223 is shorter than that of the pillars 220 and the rotor magnets 23. Thus, the inner circumferential surfaces of the upper end portions of the rotor magnets 23 are radially opposed to the wall portion 223. However, the majorities of the inner circumferential surfaces of the rotor magnets 23 are exposed from the magnet holder 22 and are opposed to the stator 13.

By installing the cylindrical wall portion 223 which extends axially downward from the lower end of the second ring 222, it is possible to increase the strength of the magnet holder 22. Furthermore, by disposing the wall portion 223 at the radial inner side of the rotor magnets 23, it is possible to restrain the upper ends of the rotor magnets 23 from moving radially inward from the magnet accommodation portions 224. In other words, the positioning of the rotor magnets 23 can be performed in the radial direction. As shown in FIG. 1, the wall portion 223 is disposed axially above the cores 31 of the stator 13. For that reason, the wall portion 223 does not affect the size of gaps between the cores 31 of the stator 13 and the rotor magnets 23.

The magnet accommodation portions 224 are spaces in which the rotor magnets 23 are accommodated. Each of the magnet accommodation portions 224 is interposed between the circumferentially-adjoining pillars 220. The second ring 222 is disposed axially above the magnet accommodation portions 224. The wall portion 223 is disposed radially inward of the upper ends of the magnet accommodation portions 224. The first ring 221 is disposed radially outward of the lower ends of the magnet accommodation portions 224.

The lower surface of the second ring 222 is disposed in radial inner regions of the upper surfaces of the magnet accommodation portions 224. Radial outer regions of the upper surfaces of the magnet accommodation portions 224 are opened. The inner circumferential surface of the first ring 221 is disposed in the regions near the axial lower ends of the outer circumferential surfaces of the magnet accommodation portions 224. Other regions of the outer circumferential surfaces of the magnet accommodation portions 224 are opened. The outer circumferential surface of the second ring 222 is disposed in the regions near the axial upper ends of the inner circumferential surfaces of the magnet accommodation portions 224. Other regions of the inner circumferential surfaces of the magnet accommodation portions 224 are opened. The lower surfaces of the magnet accommodation portions 224 are opened in their entirety.

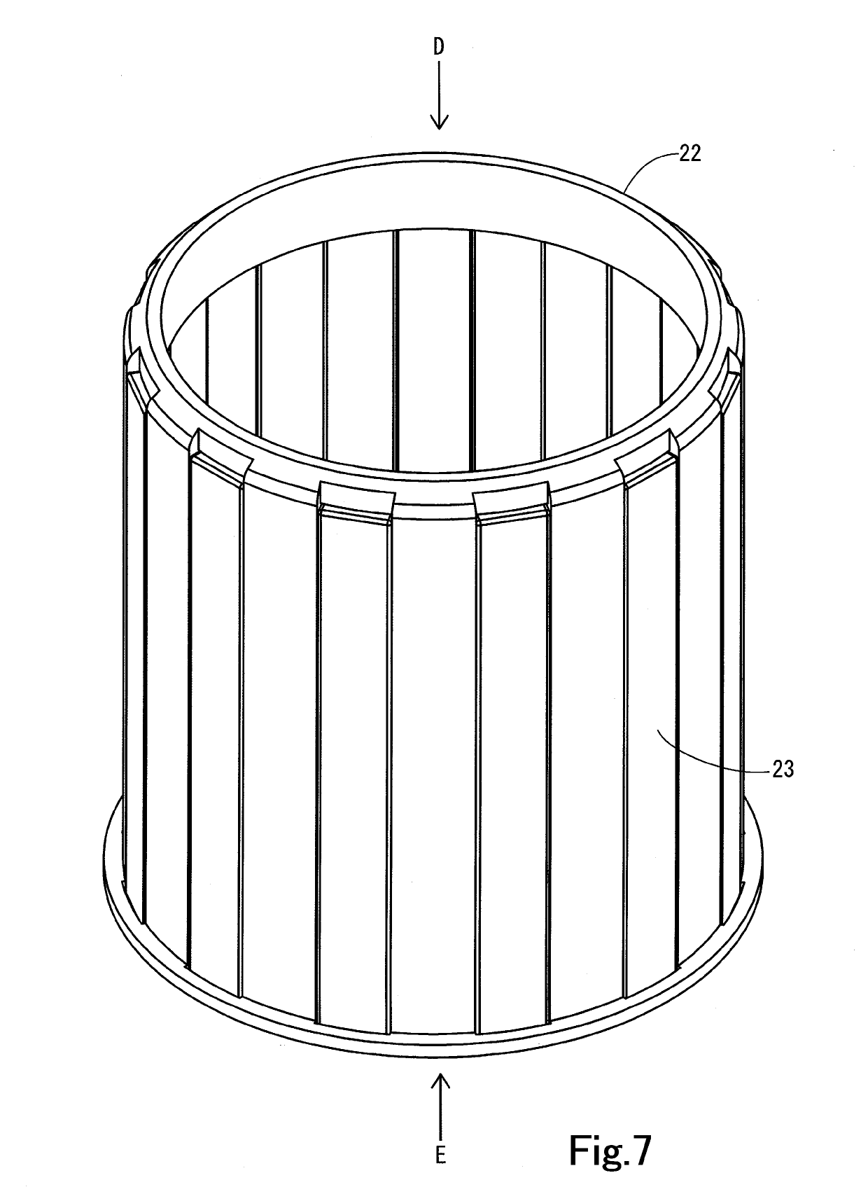

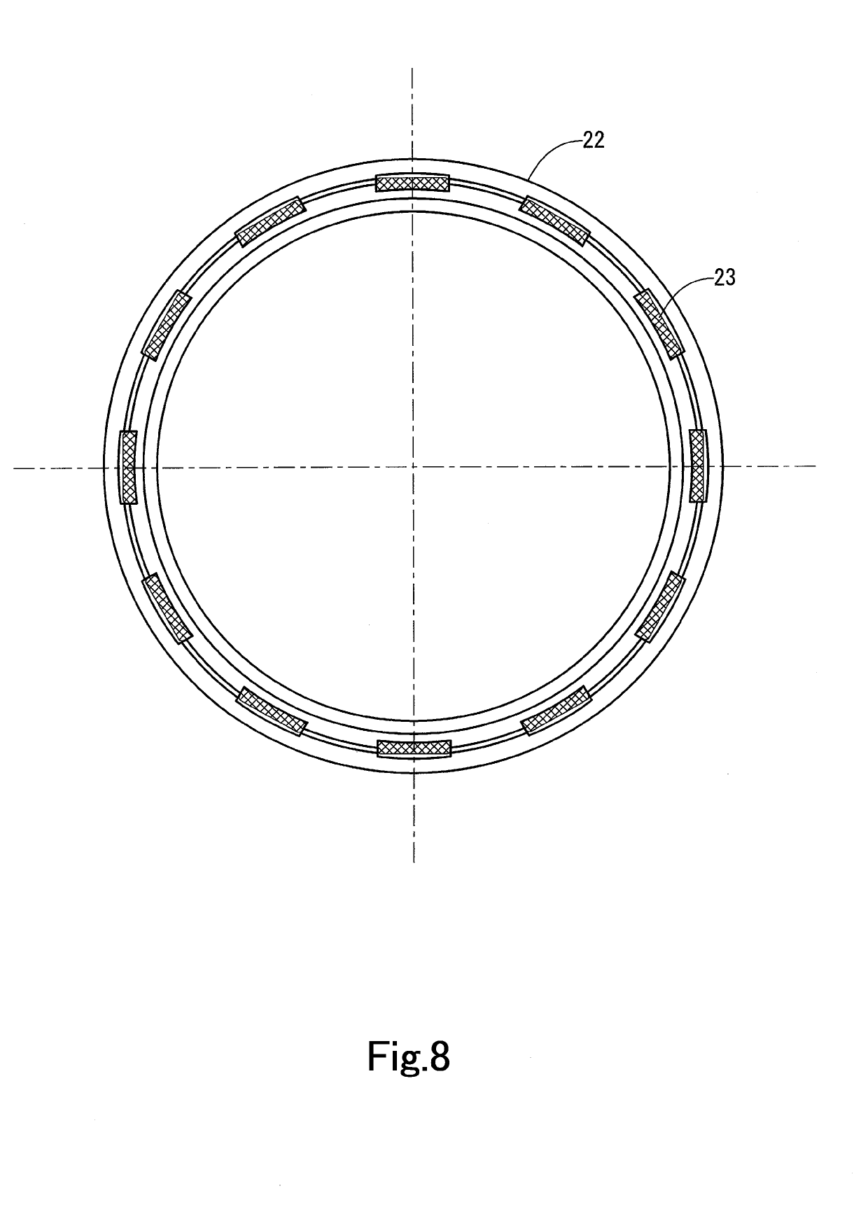

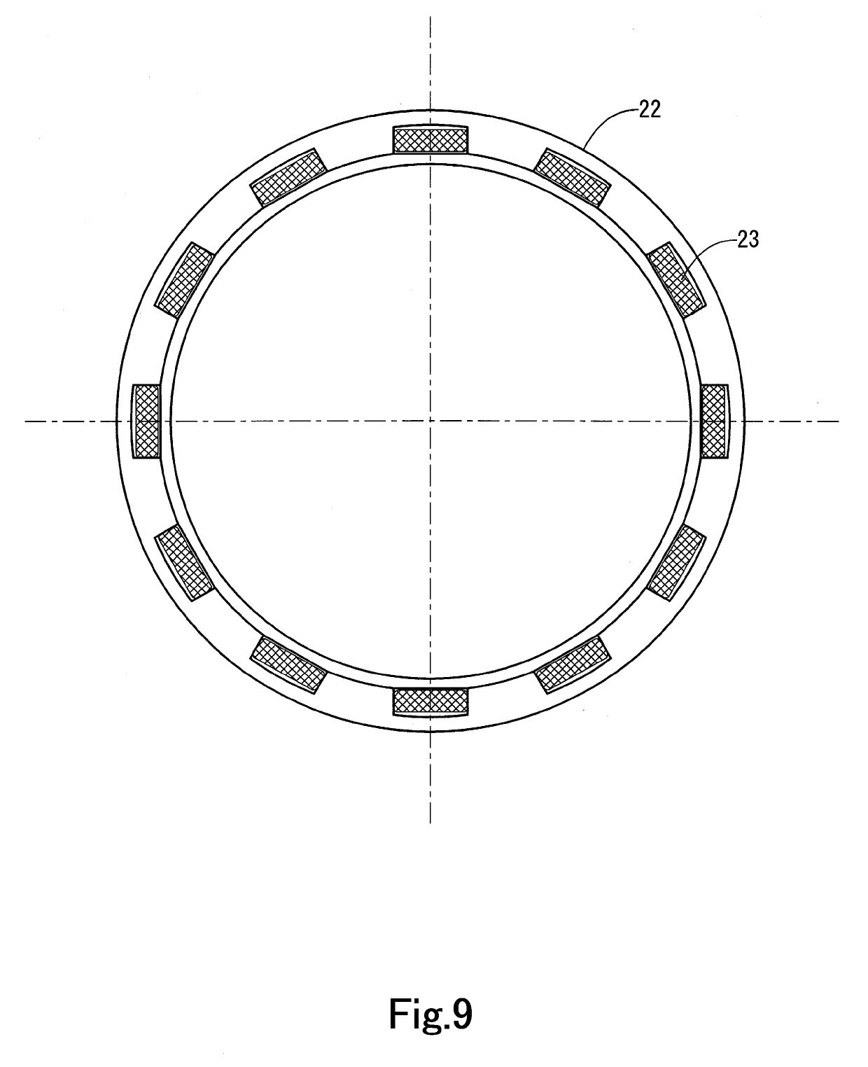

FIGS. 7 to 9 are views showing one example of the magnet holder 22 to which the rotor magnets 23 are mounted. FIG. 7 is a perspective view of the magnet holder 22 which is seen obliquely from above. FIG. 8 is a plan view (or an arrow D view) of the magnet holder 22 which is seen in the direction of an arrow D in FIG. 7. FIG. 9 is a plan view (or an arrow E view) of the magnet holder 22 which is seen in the direction of an arrow E in FIG. 7.

The rotor magnets 23 are axially-extending plate-shaped bodies having a substantially rectangular cross section and are disposed such that the thickness direction thereof coincides with the radial direction. In other words, each of the rotor magnets 23 has a flat shape with the radial inner and outer surfaces thereof becoming major surfaces. Furthermore, each of the rotor magnets 23 is magnetized with two poles such that the radial inner and outer surfaces thereof have different polarities. The rotor magnets 23 are accommodated within the magnet accommodation portions 224 and are disposed at a regular interval in the circumferential direction. The rotor magnets 23 adjoining each other are disposed such that the polarities thereof differ from each other. On the inner circumferential surface of the rotor 12, an N pole and an S pole appear alternately at a regular interval in the circumferential direction.

In general, plate-shaped magnets are less expensive than magnets having other shapes. For that reason, by employing the plate-shaped rotor magnets 23, it is possible to reduce the manufacturing cost of the motor M1. Accordingly, high-priced magnets capable of forming stronger magnetic fields, e.g., sintered neodymium magnets, can be used as the rotor magnets 23.

The rotor magnets 23 are axially inserted into the magnet holder 22. The rotor magnets 23 are inserted into the magnet accommodation portions 224 from below and are moved axially upward along the pillars 220 adjoining each other at the circumferential opposite sides. The movement of the rotor magnets 23 is stopped as the upper ends of the rotor magnets 23 make contact with the lower surface of the second ring 222.

Accordingly, when the rotor magnets 23 are accommodated within the magnet accommodation portions 224, the circumferential opposite end surfaces of the rotor magnets 23 are respectively opposed to the adjoining pillars 220. Thus, the positioning of the rotor magnets 23 in the circumferential direction is performed by the circumferential end surfaces of the pillars 220.

Furthermore, the radial inner regions of the upper end surfaces of the rotor magnets 23 are opposed to the second ring 222. Thus, the positioning of the rotor magnets 23 in the axial direction is performed by the lower surface of the second ring 222. The remaining regions of the upper end surfaces of the rotor magnets 23 are exposed from the magnet holder 22.

The lower end regions of the radial outer surfaces of the rotor magnets 23 are opposed to the first ring 221. The remaining regions of the radial outer surfaces of the rotor magnets 23 are exposed from the magnet holder 22 and are opposed to the rotor holder 21. The upper end regions of the radial inner surfaces of the rotor magnets 23 are opposed to the wall portion 223. The remaining regions of the radial inner surfaces of the rotor magnets 23 are exposed from the magnet holder 22 and are opposed to the stator 13. Accordingly, the positioning of the rotor magnets 23 in the radial direction is performed by the inner circumferential surface of the first ring 221 and the outer circumferential surface of the wall portion 223.

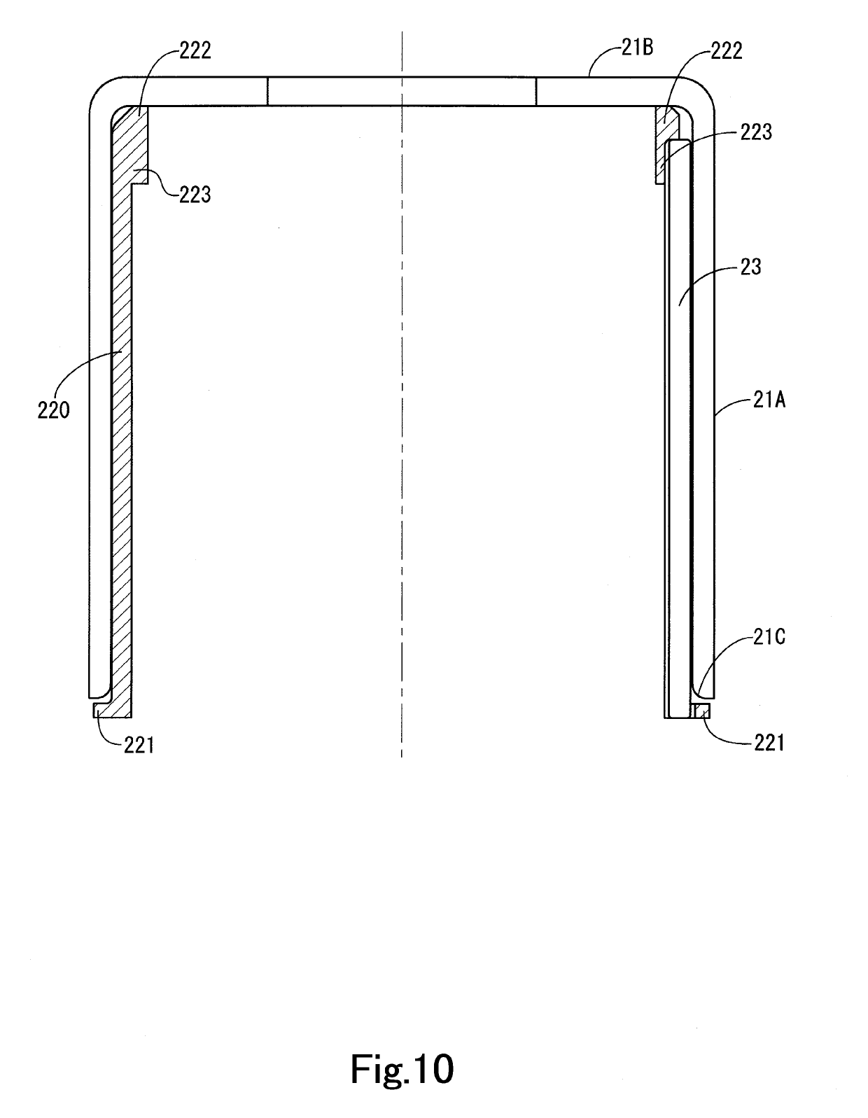

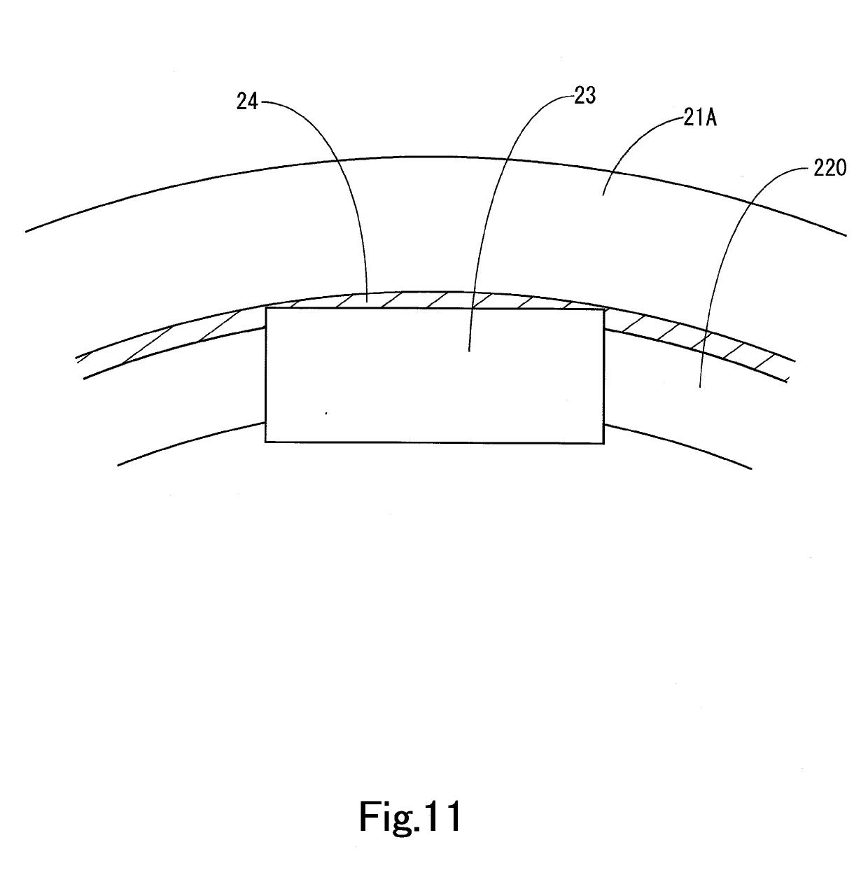

FIGS. 10 and 11 are views showing one example of the rotor holder 21 to which the magnet holder 22 is mounted. Just like FIG. 6, FIG. 10 is a sectional view taken along a cutting line C-C in FIG. 4. FIG. 11 is a partially enlarged view showing a cross section taken along a cutting line orthogonal to the axial direction. Only the major parts are shown in FIGS. 10 and 11.

The magnet holder 22 is axially inserted into the rotor holder 21. The upper end portion of the magnet holder 22 is inserted into the rotor holder 21 from below. The magnet holder 22 is moved axially upward along the inner circumferential surface of the cylinder portion 21A. The movement of the magnet holder 22 is stopped as the upper end of the magnet holder 22 makes contact with the lower surface of the cover portion 21B of the rotor holder 21.

Since the outer diameter of the first ring 221 is larger than the inner diameter of the rotor holder 21, the lower end of the magnet holder 22 cannot be inserted into the rotor holder 21. Thus, the orientation of the magnet holder 22 inserted into the rotor holder 21 can be uniquely determined. This makes it possible to facilitate the assembly work. Since the upper edge of the outer circumferential surface of the second ring 222 has a round shape or a taper shape, it is possible to facilitate the assembly work by which the magnet holder 22 is inserted into the rotor holder 21.

When the magnet holder 22 is accommodated within the rotor holder 21, the upper end of the magnet holder 22 is opposed to the cover portion 21B of the rotor holder 21. The positioning of the magnet holder 22 in the axial direction is performed by the lower surface of the cover portion 21B. In this state, the upper surface of the first ring 221 is opposed to the lower end of the cylinder portion 21A of the rotor holder 21, namely the peripheral edge of the opening portion 21C, without making contact with the same.

The rotor holder 21 and the magnet holder 22 are fixed to each other by an adhesive agent 24. The outer circumferential surfaces of the pillars 220 of the magnet holder 22 are fixed to the inner circumferential surface of the cylinder portion 21A of the rotor holder 21 by the adhesive agent 24. Furthermore, the upper end of the second ring 222 of the magnet holder 22 is fixed to the lower surface of the cover portion 21B of the rotor holder 21 by the adhesive agent 24. Moreover, the radial outer surface of the rotor magnets 23 is fixed to the inner circumferential surface of the cylinder portion 21A of the rotor holder 21 by the adhesive agent 24.

Since the radial outer surface of each of the rotor magnets 23 is planar, the circumferential center region thereof is opposed to the inner circumferential surface of the cylinder portion 21A of the rotor holder 21 across a gap. The adhesive agent 24 is disposed in this gap. In contrast, one or both circumferential ends of the radial outer surface of each of the rotor magnets 23 make contact with the inner circumferential surface of the cylinder portion 21A of the rotor holder 21. Thus, the rotor magnets 23 are fixed to the rotor holder 21 using the adhesive agent 24 and are brought into contact with the rotor holder 21. The rotor magnets 23 constitute a magnetic circuit which uses the rotor holder 21 as a back yoke.

By making the rotor magnets 23 thicker than the pillars 220, the rotor magnets 23 can be reliably brought into contact with the rotor holder 21. It is also possible to reduce the gap between the rotor magnets 23 and the stator 13.

The second ring 222 is disposed radially inward of the outer circumferential surfaces of the pillars 220. For that reason, even if the adhesive agent 24 pushed axially upward when inserting the magnet holder 22 after the adhesive agent 24 is applied on the inner circumferential surface of the rotor holder 21, the adhesive agent 24 remains on the inner circumferential surface of the rotor holder 21 corresponding to the rotor magnets 23. It is therefore possible to reliably fix the rotor magnets 23 to the inner circumferential surface of the rotor holder 21.

In one preferred embodiment of the present invention, there has been described an example of the motor M1 in which the rotor 12 is fixed to the shaft 10 with the hub 11 interposed therebetween. However, the motor to which the present invention is applied is not limited to the aforementioned configuration. For example, it may be possible to employ a configuration in which the rotor 12 is directly fixed to the shaft 10 by press-fitting the shaft 10 into the through-hole of the rotor holder 21.

In one preferred embodiment of the present invention, there has been described an example in which the cross section of the rotor magnets 23 has a rectangular shape. In another preferred embodiment of the present invention, description will be made on a case where the cross section of the rotor magnets 23 has a shape other than the rectangular shape.

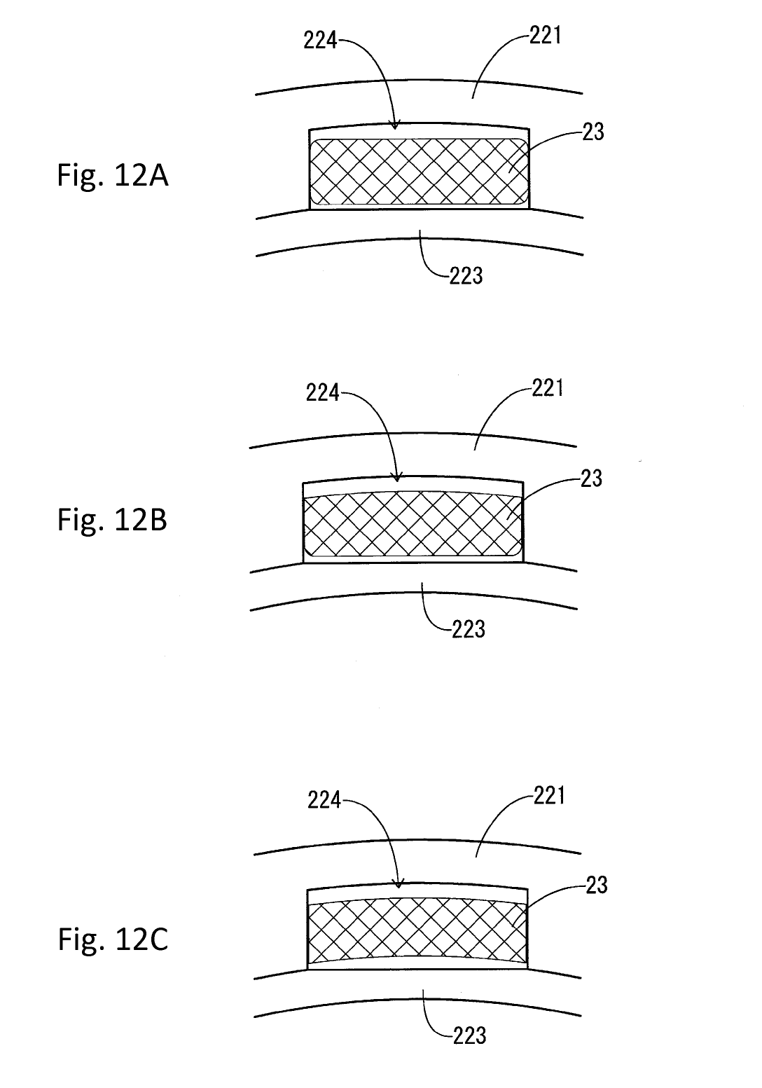

FIGS. 12A to 12C are views showing different configuration examples of rotor magnets 23 according to another preferred embodiment. In FIGS. 12A to 12C, there are shown enlarged plan views of the magnet holder 22 which is seen from the axial lower side after the rotor magnets 23 are mounted to the magnet holder 22. In FIG. 12A, there is illustrated a case where, just like the aforementioned embodiment, the cross section of the rotor magnet 23 has a rectangular shape. In FIG. 12B, there is illustrated a case where the cross section of the rotor magnet 23 has a bulging shape. In this rotor magnet 23, the radial inner surface is planar while the radial outer surface is formed of a portion of a cylindrical surface. In FIG. 12C, there is illustrated a case where the cross section of the rotor magnet 23 has an arc shape. In this rotor magnet 23, the radial inner and outer surfaces are formed of some portions of concentric cylindrical surfaces.

In one preferred embodiment of the present invention, there has been described an example in which the upper end of the magnet holder 22 makes contact with the cover portion 21B of the rotor holder 21. In a further preferred embodiment of the present invention, description will be made on a case where the first ring 221 of the magnet holder 22 makes contact with the lower end of the rotor holder 21.

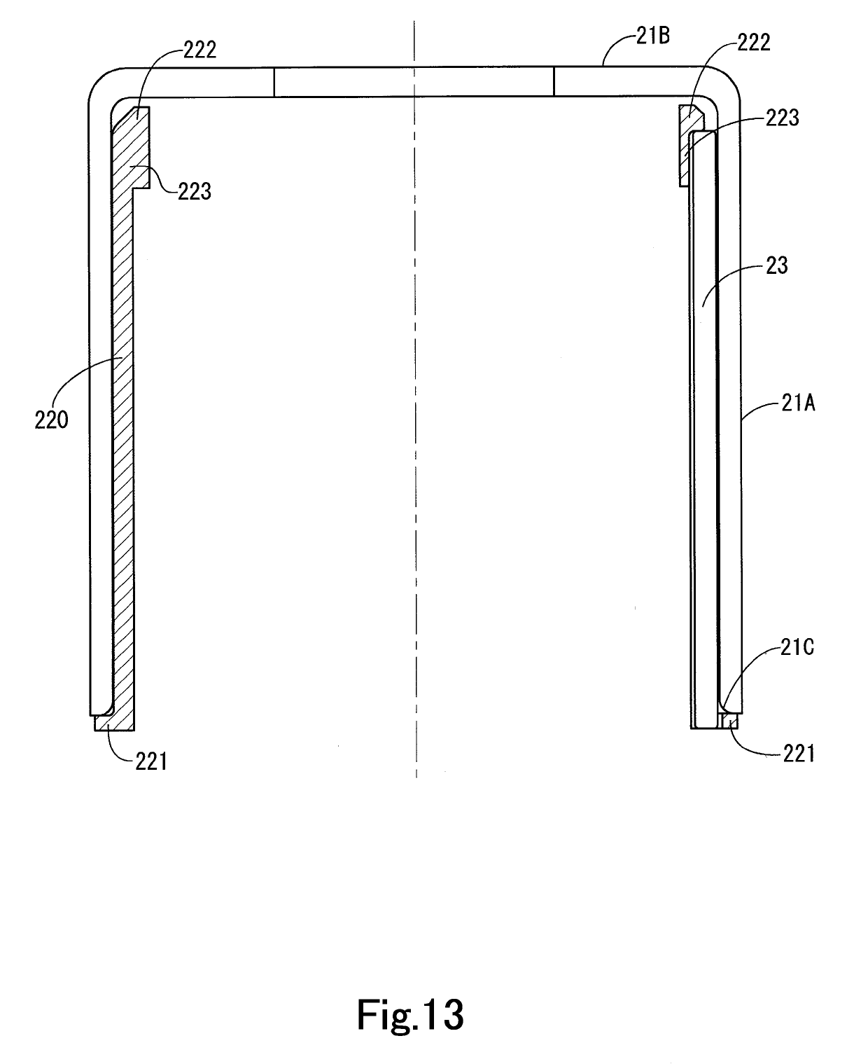

FIG. 13 is a view showing one configuration example of major parts of a motor M1 according to a further preferred embodiment of the present invention. In FIG. 13, there is illustrated one example of the rotor holder 21 to which the magnet holder 22 is mounted. Just like FIGS. 6 and 10, FIG. 13 is a sectional view taken along a cutting line c-c in FIG. 4. If the magnet holder 22 is inserted into the rotor holder 21 from the axial lower side, the movement of the magnet holder 22 is stopped as the first ring 221 thereof makes contact with the lower end of the rotor holder 21. Thus, when the magnet holder 22 is accommodated within the rotor holder 21, the upper surface of the first ring 221 of the magnet holder 22 is opposed to the peripheral edge of the opening portion 21C of the rotor holder 21. The positioning of the magnet holder 22 in the axial direction is performed by the lower end of the rotor holder 21. In this state, the upper end of the magnet holder 22 is opposed to the cover portion 21B of the rotor holder 21 without making contact with the same.

If the cylinder portion 21A and the cover portion 21B of the rotor holder 21 are formed by a press work and if the lower end of the rotor holder 21 is formed by a radial cutting work, the machining accuracy of the lower end of the rotor holder 21 becomes lower than the machining accuracy of the cover portion 21B. For that reason, as described in respect of the aforementioned embodiment, it is more preferable that the positioning of the magnet holder 22 in the axial direction is performed using the cover portion 21B.

In one preferred embodiment of the present invention, there has been described an example in which the upper end of the magnet holder 22 makes contact with the cover portion 21B of the rotor holder 21. In a still further preferred embodiment of the present invention, description will be made on a case where the round portion or the taper portion of the first ring 221 of the magnet holder 22 makes contact with the round portion or the taper portion of the upper end of the inner surface of the cylinder portion 21A of the rotor holder 21.

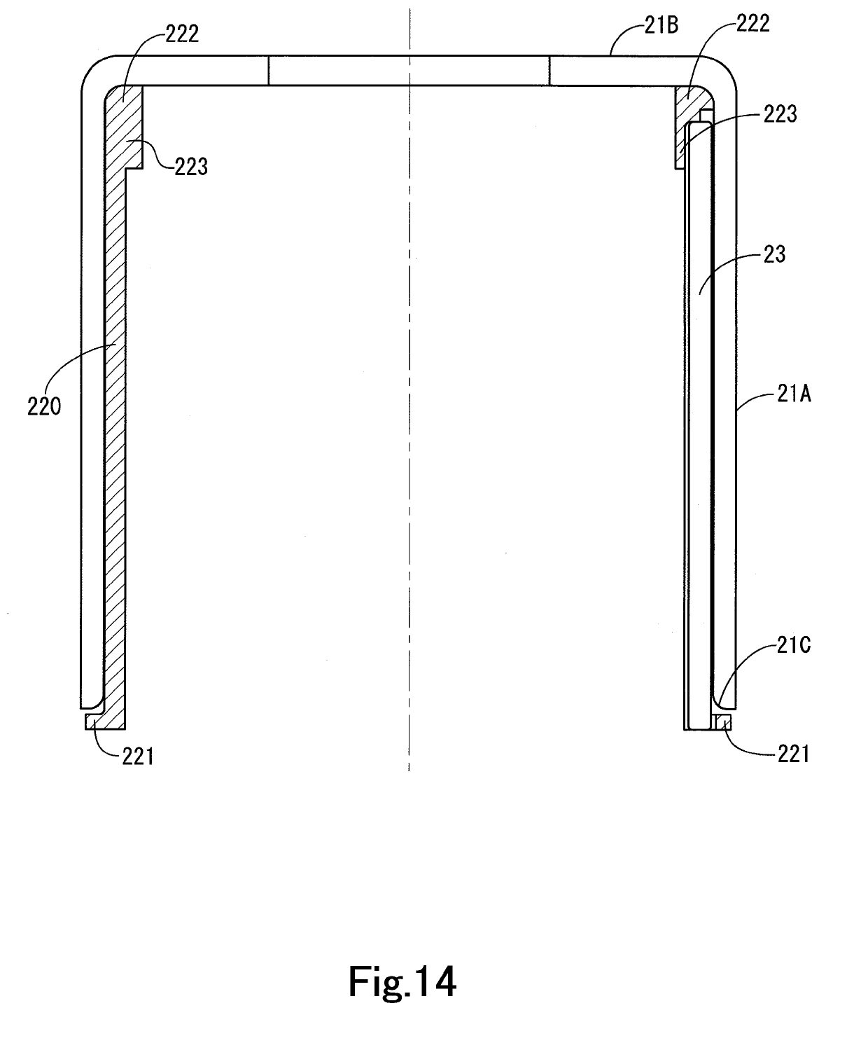

FIG. 14 is a view showing one configuration example of major parts of a motor M1 according to a still further preferred embodiment of the present invention. In FIG. 14, there is illustrated one example of the rotor holder 21 to which the magnet holder 22 is mounted. Just like FIG. 13, FIG. 14 is a sectional view taken along a cutting line C-C in FIG. 4.

The magnet holder 22 includes a round portion formed in the upper peripheral edge of the second ring 222. Furthermore, the rotor holder 21 includes a round portion formed at the upper end of the cylinder portion 21A. When the magnet holder 22 is accommodated within the rotor holder 21, the round portion of the magnet holder 22 makes contact with the inner surface of the round portion of the rotor holder 21. This makes it possible to perform the positioning of the magnet holder 22 with respect to the rotor holder 21 in the axial direction and the radial direction and to increase the fixing force of the magnet holder 22 with respect to the rotor holder 21.

In case where the rotor holder 21 and the magnet holder 22 include taper portions in place of the round portions, the taper portion of the magnet holder 22 makes contact with the taper portion of the inner surface of the rotor holder 21. Thus, the same effects as mentioned above are obtained.

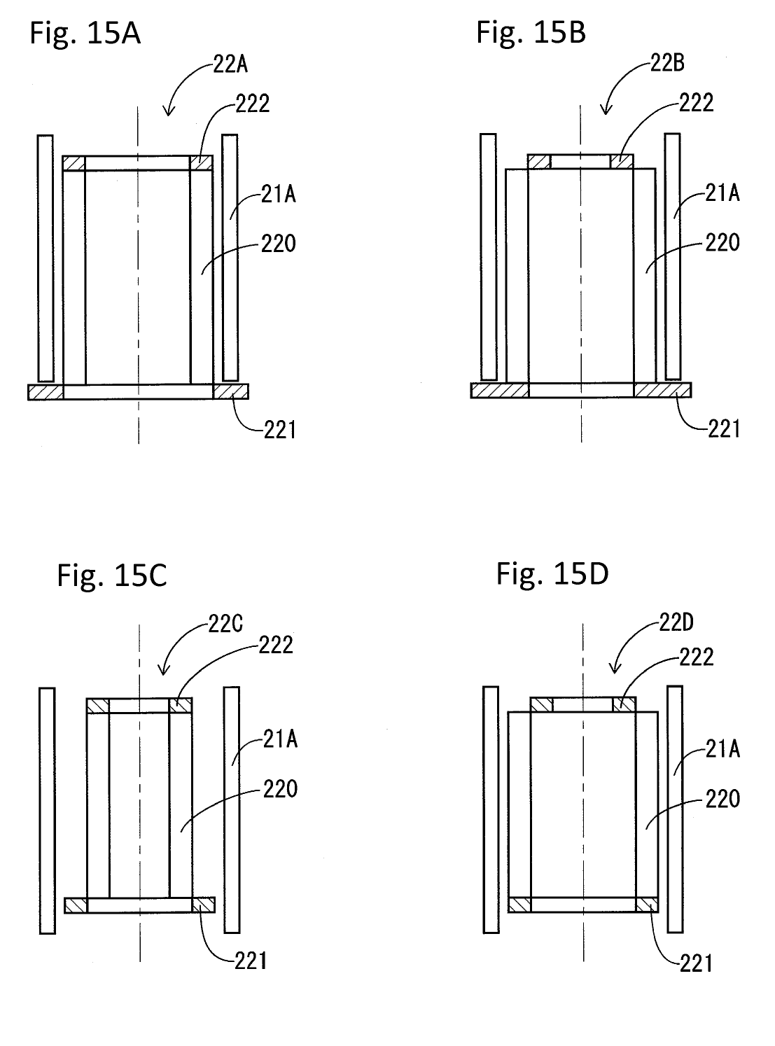

FIGS. 15A to 15D are views showing different configuration examples of major parts of a motor M1 according to a yet still further preferred embodiment of the present invention. In FIGS. 15A to 15D, there are illustrated magnet holders 22A to 22D as different modifications of the magnet holder 22. Only the pillars 220, the first ring 221 and the second ring 222, which constitute each of the magnet holders 22A to 22D, and the cylinder portion 21A, which constitutes the rotor holder 21, are shown in FIG. 15.

In the magnet holder 22A shown in FIG. 15A, the first ring 221 is disposed radially outward of the outer circumferential surfaces of the pillars 220. The second ring 222 is disposed radially inward of the outer circumferential surfaces of the pillars 220. Moreover, the outer circumferential surface of the first ring 221 is disposed radially outward of the inner circumferential surface of the cylinder portion 21A of the rotor holder 21.

In the magnet holder 22B shown in FIG. 15B, the first ring 221 is disposed radially outward of the inner circumferential surfaces of the pillars 220. The second ring 222 is disposed radially inward of the inner circumferential surfaces of the pillars 220. Moreover, the outer circumferential surface of the first ring 221 is disposed radially outward of the inner circumferential surface of the cylinder portion 21A of the rotor holder 21.

In the magnet holder 22C shown in FIG. 15C, unlike the magnet holder 22A shown in FIG. 15A, the outer circumferential surface of the first ring 221 is disposed radially inward of the inner circumferential surface of the cylinder portion 21A of the rotor holder 21.

In the magnet holder 22D shown in FIG. 15D, unlike the magnet holder 22B shown in FIG. 15B, the outer circumferential surface of the first ring 221 is disposed radially inward of the inner circumferential surface of the cylinder portion 21A of the rotor holder 21.

All the first rings 221 of the magnet holders 22A to 22D are disposed radially outward of the corresponding second rings 222. In each of the magnet holders 22A to 22D, the first ring 221 is disposed radially outward of the outer circumferential surfaces of the pillars 220, or the second ring 222 is disposed radially inward of the inner circumferential surfaces of the pillars 220. Thus, all the magnet holders 22A to 22D can be one-piece molded using a two-direction removal mold. Furthermore, it is possible to axially insert the rotor magnets 23.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor, comprising:
a stationary unit; and
a rotary unit arranged to rotate with respect to the stationary unit about a center axis extending in an up-down direction,
wherein the rotary unit includes a substantially cylindrical rotor holder, a plurality of magnets disposed radially inward of the rotor holder and arranged along a circumferential direction, and a non-magnetic magnet holder fixed to an inner circumferential surface of the rotor holder and arranged to hold the magnets,
the magnet holder includes a plurality of pillars extending in the up-down direction and arranged to position the magnets in the circumferential direction, and a first ring and a second ring arranged to interconnect the pillars at positions spaced apart in the up-down direction,
the first ring is positioned radially outward of the second ring, and
the second ring is positioned radially inward of outer circumferential surfaces of the pillars.

2. The motor of claim 1, wherein each of the magnets is disposed between the pillars adjoining each other in the circumferential direction, and
the first ring is positioned radially outward of the pillars, or the second ring is positioned radially inward of the pillars.

3. The motor of claim 1, wherein the rotor holder has a closed-top cylinder shape,
the second ring is positioned axially above the first ring, and
an outer circumferential surface of the first ring is positioned radially outward of the inner circumferential surface of the rotor holder.

4. The motor of claim 2, wherein the rotor holder has a closed-top cylinder shape,
the second ring is positioned axially above the first ring, and
an outer circumferential surface of the first ring is positioned radially outward of the inner circumferential surface of the rotor holder.

5. The motor of claim 3, wherein an upper end of the first ring is arranged to make contact with a peripheral edge of an opening of the rotor holder.

6. The motor of claim 4, wherein an upper end of the first ring is arranged to make contact with a peripheral edge of an opening of the rotor holder.

7. The motor of claim 3, wherein an upper end of the second ring is positioned axially above upper ends of the pillars, and
an upper peripheral edge of the second ring is inclined such that the diameter thereof grows smaller upward.

8. The motor of claim 4, wherein an upper end of the second ring is positioned axially above upper ends of the pillars, and
an upper peripheral edge of the second ring is inclined such that the diameter thereof grows smaller upward.

9. The motor of claim 5, wherein an upper end of the second ring is positioned axially above upper ends of the pillars, and
an upper peripheral edge of the second ring is inclined such that the diameter thereof grows smaller upward.

10. The motor of claim 6, wherein an upper end of the second ring is positioned axially above upper ends of the pillars, and
an upper peripheral edge of the second ring is inclined such that the diameter thereof grows smaller upward.

11. The motor of claim 7, wherein an upper end of the second ring is arranged to make contact with a lower surface of a cover portion of the rotor holder.

12. The motor of claim 8, wherein an upper end of the second ring is arranged to make contact with a lower surface of a cover portion of the rotor holder.

13. The motor of claim 7, wherein an upper peripheral edge of the second ring has a round shape or a taper shape and makes contact with a rounded or tapered inner surface of an upper end of a cylinder portion of the rotor holder.

14. The motor of claim 1, wherein an inner circumferential surface of the second ring is positioned radially inward of inner circumferential surfaces of the pillars and is provided with a wall portion axially extending from an inner periphery of the second ring.

15. The motor of claim 3, wherein the wall portion is radially opposed to the magnets.

16. The motor of claim 15, wherein the wall portion is shorter in axial length than the magnets.

17. The motor of claim 1, wherein the rotor holder and the magnet holder are fixed to each other by an adhesive agent.

18. The motor of claim 1, wherein the magnets are plate-shaped bodies, and
at least one of circumferential end portions of a radial outer surface of each of the magnets makes contact with the inner circumferential surface of the rotor holder.

19. The motor of claim 1, wherein the magnets are sintered neodymium magnets.

20. The motor of claim 1, wherein an outer circumferential surface of the second ring is positioned radially inward of the outer circumferential surfaces of the pillars.
